(19) United States
(12) Patent Application Publication
(10) Pub. No.: US 2015/0080145 A1
(43) Pub. Date: Mar. 19, 2015

(54) GOLF CLUB LABELING METHOD

(71) Applicant: CALLAWAY GOLF COMPANY, Carlsbad, CA (US)

(72) Inventors: Kurt A. Roller, Carlsbad, CA (US); Sam R. Hiatt, Vista, CA (US)

(73) Assignee: CALLAWAY GOLF COMPANY, Carlsbad, CA (US)

(21) Appl. No.: 14/026,728

(22) Filed: Sep. 13, 2013

(51) Int. Cl. B32B 38/00; B32B 37/06; B32B 37/14; A63B 53/00

(52) U.S. Cl. CPC B32B 38/145; A63B 53/00; B32B 37/06; B32B 37/142; B32B 37/144; B32B 38/0004; B32B 2307/738
USPC 473/282; 156/86

(57) ABSTRACT

A method of labeling products, including golf club products, is disclosed herein. In particular, a golf club comprising a head, a shaft, a grip, and at least one shrink wrap label comprising identifying information that refers to the golf club, wherein the at least one shrink wrap label is removably affixed to at least one of the head, shaft, and grip, is disclosed and claimed herein. The present invention also relates to methods of printing and affixing removable, shrink wrapped labels to golf club products.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to a method of labeling products. In particular, the present invention relates to a method of printing a label directly on shrink wrap that is then applied to a product.

2. Description of the Related Art

Consumer products typically are labeled after production so that they can be tracked during shipment and identified before, during, and after sale. In the golf industry, for example, manufacturers typically print tracking or identification codes, such as UPC barcodes, on a paper label and the affix the label to the golf club on a shaft or grip region. These clubs are then packaged and shipped for sale. These labels are affixed with adhesive and are difficult to remove from the product once they are sold. Even if they are removed, they often leave unsightly marks or residue on the golf club product. In other industries, identification codes or labels are printed directly on the product, making it nearly impossible for a consumer to remove an unsightly label without damaging the product.

The prior art has failed to provide a method for labeling products that both minimizes waste and allows for easy removal of those labels from the product after sale.

### BRIEF SUMMARY OF THE INVENTION

It is the object of this invention to reduce the number of materials used to label and package a product such as a golf club head. It is another object of this invention to print identifying information for a product directly on a piece of packaging, and in particular, on shrink wrapping that protects the product without obscuring its features from view,

One aspect of the invention is a golf club comprising a head, a shaft, a grip, and at least one shrink wrap label comprising identifying information that refers to the golf club, wherein the at least one shrink wrap label is removably affixed to at least one of the head, shaft, and grip. In some embodiments, the shrink wrap label may manufactured by printing information directly on shrink wrapping material, which may be composed of material selected from the group consisting of polyolefin and PVC, or any type of heat sensitive polymeric material. In some embodiments, the shrink wrap label may have a width of 20 mm to 150 mm and a length of 50 mm to 100 mm, and in further embodiments, may have a width of approximately 100 mm, a length of approximately 70 mm, and a lay flat width of 48 mm.

In some embodiments, the identifying information may be selected from the group consisting of golf club head type, golf club shaft type, country of manufacture, country of assembly, and SKU number. In other embodiments, the shrink wrap label may comprise an overlap seam area, which may have a width of 1 mm to 10 mm. In some embodiments, the shrink wrap label may comprise a translucent area and an opaque area, and the identifying information may be printed on the opaque area. In other embodiments, the shrink wrap label may comprise at least one set of perforations, and in some embodiments two sets of perforations, which may be cross-cut.

Another aspect of the present invention is a method of labeling a golf product, the method comprising inserting shrink wrap material into a printer, selecting identification information for the golf product, printing the identification information on the shrink wrap material to form a printed label, removing the printed label from the printer, placing the printed label on the golf product, and applying heat to the printed label so that the printed label shrinks to fit to the golf product. In some embodiments, the golf product may be a golf club comprising a shaft and a grip, and the step of placing the printed label on the golf product may comprise placing the printed label one of the grip and the shaft. In other embodiments, the step of placing the printed label on the golf product may comprise sliding the printed label over an end of the grip. In still other embodiments, he step of placing the printed label on the golf product may comprise wrapping the printed label around one of the grip and the shaft so that the printed label overlaps a portion of itself.

Yet another aspect of the present invention is a method of labeling a golf club comprising a head, a shaft, and a grip, the method comprising inserting shrink wrap material into a printer, the shrink wrap material having an overall width of 100 mm to 150 mm, an overall length of 200 mm to 300 mm, and comprising a plurality of perforation lines, selecting identification information for the golf product, printing the identification information on the shrink wrap material to form a printed sheet, removing the printed sheet from the printer, tearing the printed sheet across at least one of the perforation lines to form a printed label, placing the printed label on at least one of the head, shaft, and grip, and applying heat to the printed label. In some embodiments, the step of placing the printed label on at least one of the head, shaft, and grip may comprise the steps of placing the printed label on an applicator and then using the applicator to place the printed label on at least one of the head, shaft, and grip. In other embodiments, the step of printing the identification information on the shrink wrap material to form a printed sheet may comprise a further step of cutting the printed sheet with the printer to facilitate its removal from the printer. In another embodiment, the method may further comprise the step of adjusting the label so that the identification information is located on a back side of at least one of the head, shaft, and grip.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a side perspective view of an exemplary golf club.

FIG. 2 is a photograph of a shrink wrap label according to the present invention.

FIG. 3 is a photograph of a shrink wrap label according to the present invention applied to a golf club grip.

FIG. 4 is a line drawing of a shrink wrap label and its preferred dimensions.

FIG. 5 is a flow chart showing a simplified method of labeling a golf product.

FIG. 6 is a flow chart showing a more detailed method f labeling a golf product.

### DETAILED DESCRIPTION OF THE INVENTION

The present invention is generally directed to a method of labeling a product, including but not limited to a golf club or components thereof using shrink wrap materials. The present invention serves to reduce the quantity and volume of materials used to identify and. package goods by combining labeling and packaging processes. When applied to golf clubs, the present invention incorporates a label that both protects and identifies all or a portion of the club.

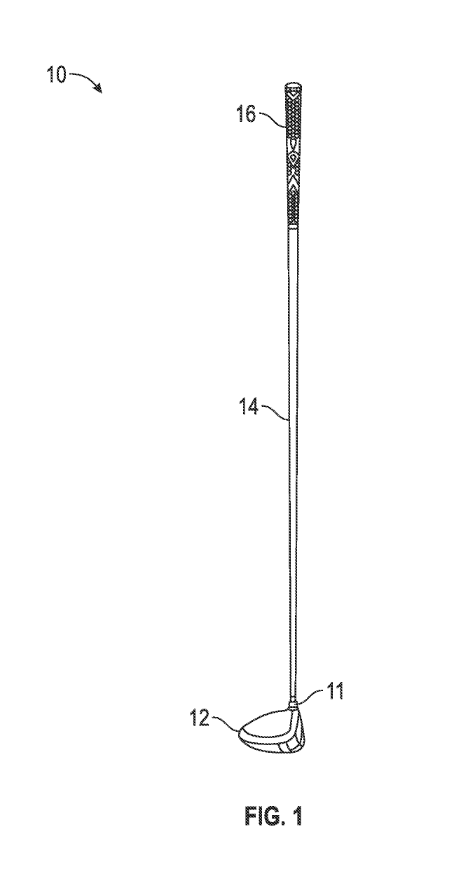

A driver-type golf club 10 that can benefit from the present invention is shown in FIG. 1. The golf club 10, which in alternative embodiments may be any wood-type, iron-type, hybrid-type, or putter-type club, includes a head 12, a shaft 14, and a grip 16. Once a manufacturer has finished manufacturing a golf club component, such as ahead 12, shaft 14, or grip 16, or finishes assembling the golf club 10, the manufacturer then affixes the label of the present invention to the individual component and/or the completed golf club 10.

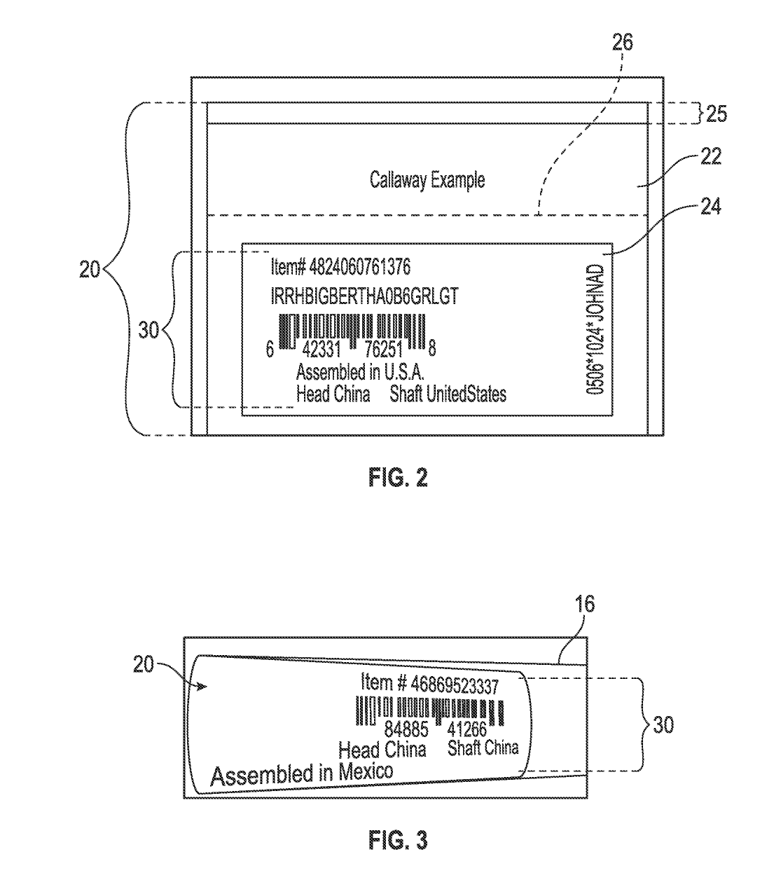

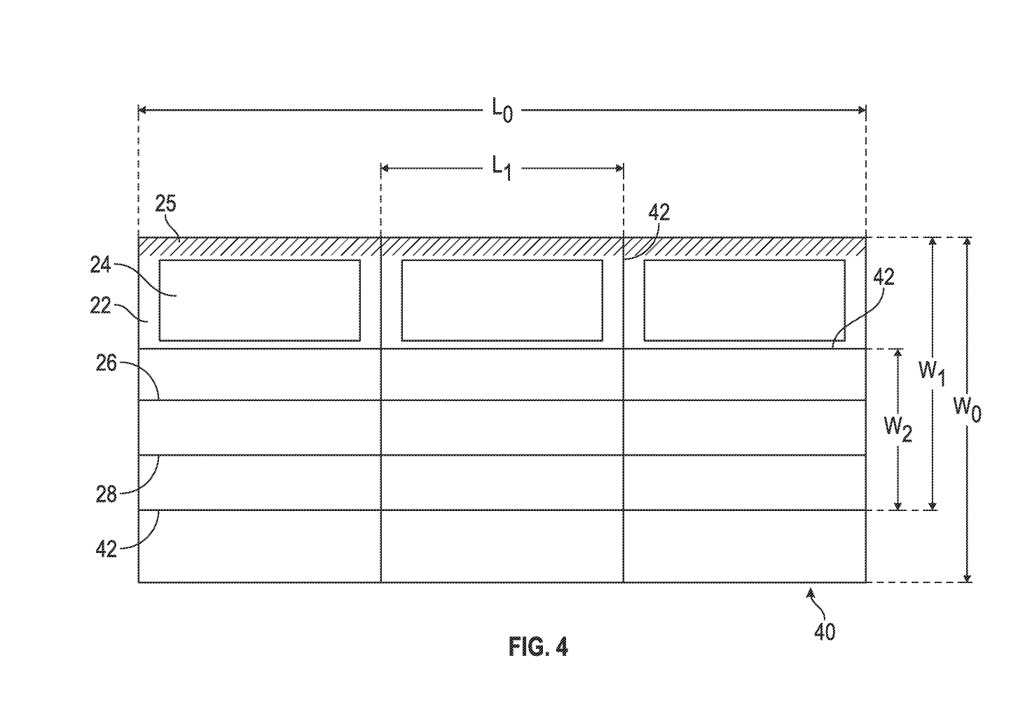

An exemplary label 20 of the present invention is shown in FIGS. 2 and 3. The label 20, which in FIG. 3 is shown affixed to a grip 16 portion of a golf club 10, comprises a translucent area 22, an opaque area 24, an overlap seam 25, and at least one perforation line 26, and more preferably two perforation lines 26, 28 (see FIG. 4), that are designed to make it easier for an end-consumer c remove the label 20 after purchasing the golf club 10. Identifying information 30 preferably is printed on the opaque area 24 for easy viewing, but in alternative embodiments it may be printed on one or both of the translucent area 22 and opaque area 24. As shown in FIGS. 2 and 3, the identifying information 30 preferably includes at least one of a country of manufacture, a country of assembly, an item SKU number, and a barcode, and more preferably includes all of this information.

The shrink wrap labels 20 of the present invention are cut or torn from a co tot s sleeve 40 of shrink wrap labels that is intersected with cross-cut perforations 42, shown in FIG. 4. The continuous sleeve 40 preferably has an overall length L₀ of 200 to 300 mm and an overall width W₀ of 100 to 200 mm, and its cross-cut perforations 42 preferably are assorted across the sleeve 40 so that individual labels 20 having a length L₁ of 50 to 100 mm and a width W₁ of 20 to 150 mm, and more preferably a length L₁ of 70 mm, a width W₁ of 100 mm, and a “lay flat” width W₂ (the portion of the label 20 that, in some embodiments, does not include printed material) of 48 mm, can be torn or cut from the sleeve 40. The sleeve shown in FIG. 4 has enough material to form three labels 20. Each label 20 also preferably includes an overlap seam 25, which has a width of 1 to 10 mm, and more preferably a width of 5 mm, where the label 20 wraps around a golf club component and overlaps itself In some embodiments, the label 20 is pre-wrapped to form a cylinder and is adhered to itself at the overlap seam 25 before being affixed to or slid over a golf club component such as a shaft 14 or a grip 16 or a hose 11 of a golf club head 12.

The shrink wrap material used for the labels 20 of the present invention preferably is a plastic such as polyolefin or PVC, or another heat-sensitive polymeric material. The shrink wrap sleeve 40 may be used with any type of printer, industrial or otherwise, including printers with cutting mechanisms built into them.

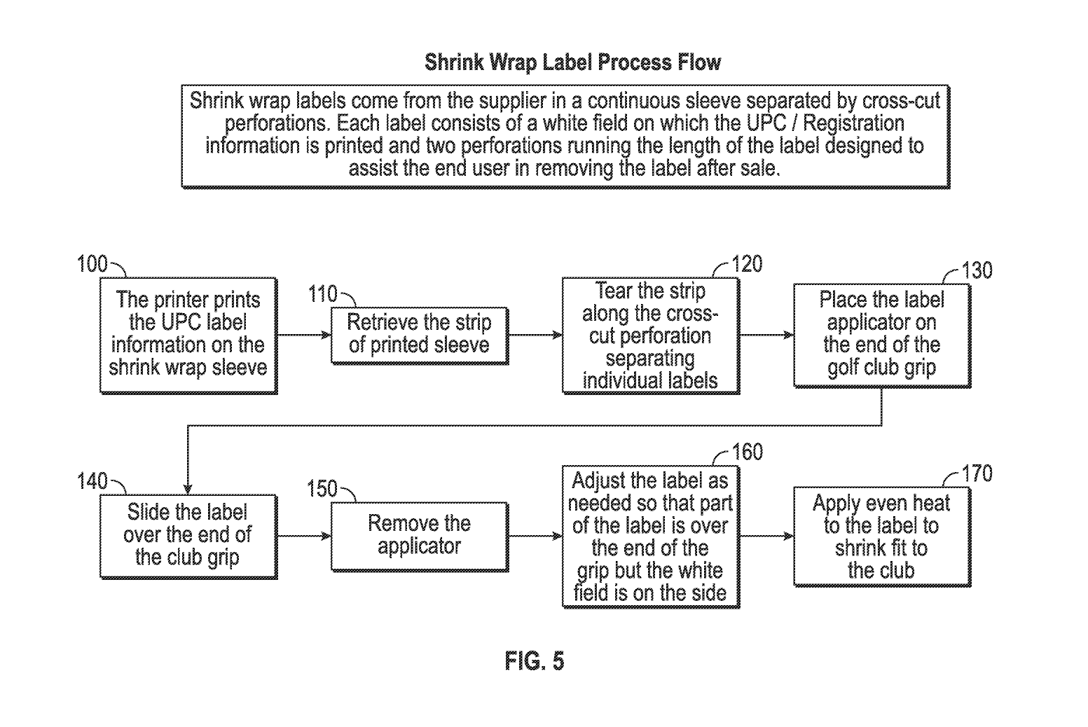

A preferred method of the present invention is shown in FIG. 5. This method comprises the steps of printing UPC label information on a shrink wrap sleeve 100, retrieving the strip of printed sleeve 110, tearing the strip of printed sleeve along cross cut perforation to separate individual labels 120, placing a label applicator on an end of a grip 16 on a golf club 130, sliding an individual label 20 over he end of the grip 140, removing the applicator 150, adjusting the label 20 as needed so that part of the label is over the end of the grip 16 but the opaque area 24 of the label 20 in disposed over a side of the grip 160, and applying heat to the label so that it shrinks to fit to the grip 170.

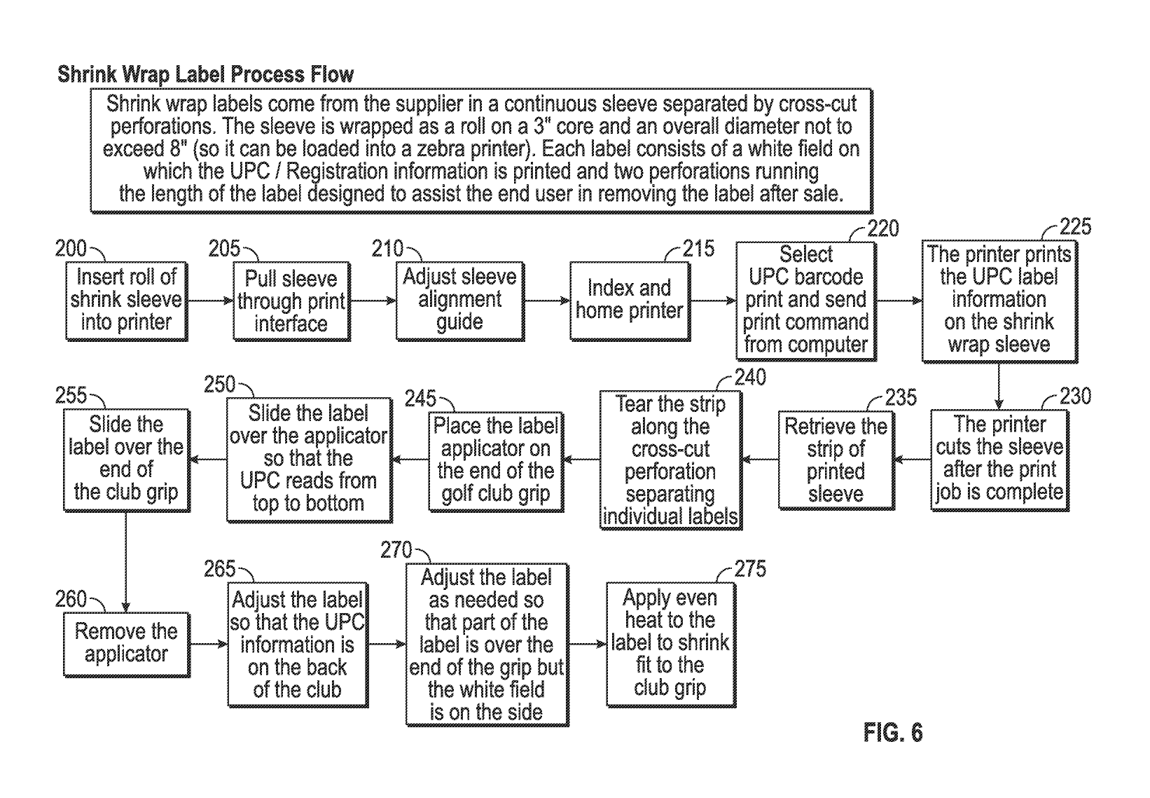

A more detailed method of the present invention is shown in FIG. 6. This method comprises the steps of inserting a roll of shrink wrap sleeve 40 into a printer 200, pulling the sleeve 40 through a print interface on the printer 205, adjusting a sleeve alignment guide on the printer 210, indexing and homing the printer 215, selecting identifying information 30 (such as a UPC barcode) and sending a print command fro a computer linked to the printer 220, printing the identifying information 30 on the shrink wrap sleeve 225, causing the printer to cut the sleeve 40 after completing the print job 230, retrieving the cut strip of printed sleeve from the printer 235, tearing the strip of printed sleeve along cross-cut perforations to separate individual labels 240, placing a label applicator on an end of a golf club grip 245, sliding a label 20 over the applicator so that the identifying information 30 reads from top to bottom 250, sliding the label 20 over an end of the grip 255, removing the applicator 260, adjusting the label 20 so that the identifying information 30 is on the back of the grip 265, adjusting the label 20 as needed so that part of the label 20 is over the end of the grip but the opaque area 24 is on the side of the grip 270, and applying an even heat to the label 20 so that it shrinks to fit the golf club grip 275.

From the foregoing it is believed that those skilled in the pertinent art will recognize the meritorious advancement of this invention and will readily understand that white the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. The methods of the present invention may be applied to any type of product of manufacture, and is not intended to be limited to use with golf clubs. The embodiments of the invention in which an exclusive property or privilege is claimed are defined in the following appended claims.

We claim as our invention:

1. A golf club comprising:
ahead;
a shaft;
a grip; and
at least one shrink wrap label comprising identifying information that refers to the golf club,
wherein the at least one shrink wrap label is removably affixed to at least one of the head, shaft, and grip.

2. The golf club of claim 1, wherein the shrink wrap label is manufactured by printing information directly on shrink wrapping material,

3. The golf club of claim 1, wherein the shrink wrapping material is composed of a material selected from the group consisting of polyolefin and PVC.

4. The golf club of claim 1, wherein the shrink wrap label has a width of 20 mm to 150 mm and a length of 50 mm to 100 mm.

5. The golf club of claim 4, wherein the shrink wrap label has a width of approximately 100 mm, a length of approximately 70 mm, and a lay flat width of 48 mm.

6. The golf club of claim 1, wherein the identifying information is selected from the group consisting of golf club head type, golf club shaft type, country of manufacture, country of assembly, and SKU number.

7. The golf club of claim 1, wherein the shrink wrap label comprises an overlap seam area.

8. The golf club of claim 7, wherein the overall seam area has a width of 1 mm to 10 mm.

9. The golf club of claim 1, wherein the shrink wrap label comprises a translucent area and an opaque area, and wherein the identifying information is printed on the opaque area.

10. The golf club of claim 1, wherein the shrink wrap label comprises at least one set of perforations.

11. The golf club of claim 10, wherein the perforations are cross-cut.

12. The golf club of claim 10, wherein the at least one set of perforations comprises two sets of perforations.

13. A method of labeling a golf product, the method comprising:
inserting shrink wrap material into a printer;
selecting identification information for the golf product;
printing the identification information on the shrink wrap material to form a printed label;
removing the printed label from the printer;
placing the printed label on the golf product; and
applying heat to the printed label so that the printed label shrinks to fit to the golf product.

14. The method of claim 13, wherein the golf product is a golf club comprising a shaft and a grip, and wherein the step of placing the printed label on the golf product comprises placing the printed label one of the grip and the shaft.

15. The method of claim 13, wherein the step of placing the printed label on the golf product comprises sliding the printed label over an end of the grip.

16. The method of claim 13, wherein the step of placing the printed label on the golf product comprises wrapping the printed label around one of the grip and the shaft so that the printed label overlaps a portion of itself.

17. A method of labeling a golf club comprising a head, a shaft, and a grip, the method comprising:
inserting shrink wrap material into a printer, the shrink wrap material having an overall width of 100 mm to 150 mm, an overall length of 200 mm to 300 mm, and comprising a plurality of perforation lines;
selecting identification information for the golf product;
printing the identification information on the shrink wrap material to form a printed sheet;
removing the printed sheet from the printer;
tearing the printed sheet across at least one of the perforation lines to form a printed label;
placing the printed label on at least one of the head, shaft, and grip; and
applying heat to the printed label.

18. The method of claim 17, wherein the step of placing the printed label on at least one of the head, shaft, and grip comprises the steps of placing the printed label on an applicator and then using the applicator to place the printed label on at least one of the head, shaft, and grip.

19. The method of claim 17, wherein the step of printing the identification information on the shrink wrap material to form a printed sheet comprises the further step of cutting the printed. sheet with the printer to facilitate its removal from the printer.

20. The method of claim 17, further comprising the step of adjusting the label so that the identification information is located on a back side of at least one of the head, shaft, and grip.
